(19) United States
(12) Patent Application Publication
(10) Pub. No.: US 2008/0140769 A1
(43) Pub. Date: Jun. 12, 2008

(54) Document Management Device and Program of the Same

(75) Inventor: Kazuo Matoba, Akashi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/872,755

(22) Filed: Oct. 16, 2007

(30) Foreign Application Priority Data
Oct. 17, 2006 (JP) 2006-283157

(51) Int. Cl. G06F 15/16

(52) U.S. Cl. 709/203

(57) ABSTRACT

There is provided a document management device and a program capable of easily informing related information held by a user to another user. A log-in user and a destination user at the time of transmission are stored in a related user information storing unit in association with the file to be transmitted as the related user of the file to be transmitted. When any one of replies from the destination user includes a related file together with the identification information of the transmitted file, an e-mail creating/analyzing unit extracts the related file to store the same in a file storing unit, and when a new related file is stored, the related user other than the user who has transmitted the related file is informed of the storage of the new related file.

This application is based on the application No. 2006-283157 filed in Japan, the contents of which are hereby incorporated by reference.

### BACKGROUND OF THE INVENTION

1. Field of the Invention

The present invention relates to a document management device and a program of the same.

2. Description of the Related Art

JP No.09-167158 A discloses a discussion supporting system under an environment where a document or the like is cooperatively created. This system is configured to store a past review history, and searches and displays a review and the like for the same portion when an operator requests a change of data corresponding to the portion.

When a plurality of persons belonging to a group work together, there may be a case where a document which belongs to one user is related to another document that belongs to another user. The configuration disclosed in Japanese Unexamined Patent Application Publication No. 09-167158 has a problem that the document had and held by one of the other users cannot easily be distributed to the rest of users.

### SUMMARY OF THE INVENTION

It is an object of the present invention to provide a document management device and a program of the same. In this device or the program, it is easy to inform another user of related information that is had and held by one user.

The object described above is achieved by a document management device according to the present invention. The document management device includes: a file information transmitter that transmits information being related to a first file to one or more destination users designated by a first user; a related user information storing unit that stores, as a related user, the destination user in association with the first file; a related file extractor that extracts a related file when a reply from any one of the destination users includes the related file together with identification information of the first file; a file storing unit that stores the related file; and a related file informer that informs the related user other than the user who has transmitted the related file when a new related file is stored in the file storing unit.

The object described above is also achieved by a program stored on a computer readable medium according to the present invention. The program stored on a computer readable medium causes a processor to operate following processes. The processes include: a file information transmitting process that transmits information being related to a first file to one or more destination users designated by a first user; a related file extracting process that extracts the related file when a reply from any one of the destination users includes the related file together with identification information of the first file; and a related file informing process that informs the related user other than the user who has transmitted the related file when a new related file is extracted.

The document management device and the program according to the present invention provide an effect of easily informing related information held by one user to another user.

Other objects and further features of the present invention will be apparent from the following detailed description when read in conjunction with the accompanying drawings.

### BRIEF DESCRIPTION OF THE DRAWINGS

In the accompanying drawings:

FIG. 1 is a diagram of an overall configuration of one example of a document management system according to an embodiment of the present invention;

FIG. 2 is a diagram of an example of a hardware structure of an MFP;

FIG. 3 is a block diagram for explaining an example of a functional configuration of the MFP 101 according to the embodiment;

FIG. 4 is a diagram for explaining an example of contents of related user information;

FIG. 5 is a diagram for explaining an example of contents of related file information;

FIG. 6 is a flowchart for explaining an example of processes of the MFP 101 when transmitting an e-mail having a file attached thereto to the outside;

FIG. 7 is a diagram of an example of a screen displayed on a display unit 12 when designating a file name to be transmitted and a destination user;

FIG. 8 is a flowchart for explaining an example of processes of the MFP 101;

FIG. 9 is a diagram of an example of a screen displayed on the display unit 12 when designating an additional file;

FIG. 10 is a flowchart for explaining an example of processes of the MFP 101;

FIG. 11 is a diagram of an example of an e-mail including information which indicates the location of the transmission file therein;

FIG. 12 is a diagram of an example of an e-mail also including information which indicates the location of the related file therein;

FIG. 13 is a diagram of an example of a reply e-mail when the reply e-mail which includes the related file being attached thereto is transmitted to the MFP 101;

FIG. 14 is a flowchart for explaining an example of processes of the MFP 101 when receiving the reply e-mail;

FIG. 15 is a diagram of an example of updated related file information;

FIG. 16 is a diagram of an example of the reply e-mail that directs to limit the destination user of the e-mail which includes the information of the related file therein; and

FIG. 17 is a diagram of an example of updated related file information when the reply e-mail that directs to limit the destination user of the e-mail which includes the information of the related file therein is received.

### DETAILED DESCRIPTION OF THE PREFERRED EMBODIMENTS

Preferred embodiments of the present invention will be described in detail with reference to the drawings. In the embodiments, multifunction peripherals (MFPs) as examples of the device to which the document management device according to the present invention is applied are illustrated.

(1) Configuration of Document Management System

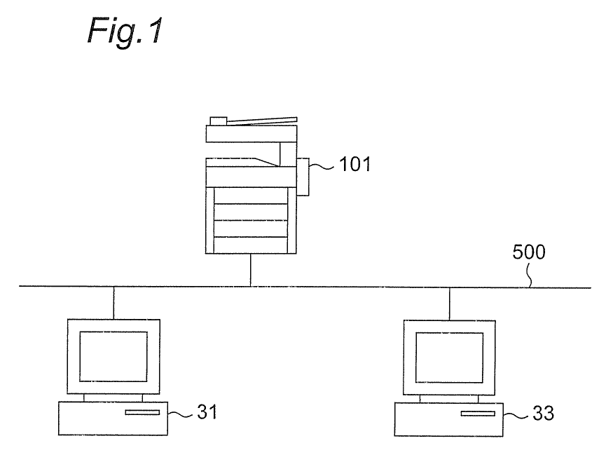

FIG. 1 is a diagram of an overall configuration of an example of a document management system according to the present embodiment. The document management system according to the present embodiment is configured by an MFP 101 to which the document management device according to the present embodiment is installed, a PC 31, and an e-mail server 33, connected to a network 500 such as a local area network (LAN).

In the MFP 101 according to the present embodiment, an electronic mail (also referred to as “e-mail” or “mail” simply, hereinafter) can be transmitted with an e-mail address of a destination being designated at the MFP 101. Image data obtained through reading a document image at a scanner unit to be described later can be transmitted as attached to an e-mail (Scan-To-E-Mail). The e-mail having transmitted is stored in, for example, the e-mail server 33. The stored e-mails can be downloaded from an information processing device such as the PC 31. At the side of the information processing device such as the PC 31, a reply e-mail to the e-mail can be transmitted to the MFP 101.

(2) Configuration of MFP 101

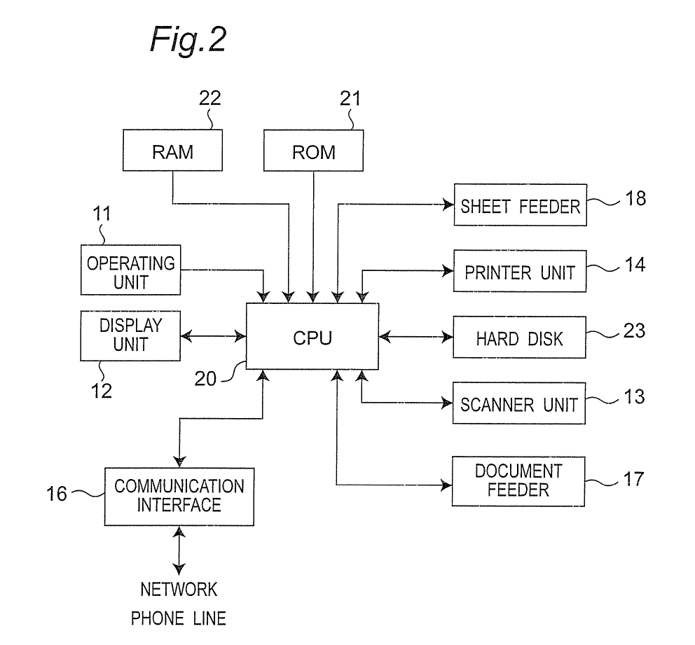

Next, the configuration of the MFP 101 will be described. FIG. 2 is a diagram showing an example of a hardware configuration of the MFP 101.

The MFP 101 includes: an operating unit 11; a display unit 12; a scanner unit 13; a printer unit 14; a communication interface 16; a document feeder 17; a sheet feeder 18; a CPU 20; a ROM 21; a RAM 22; a hard disk 23; and the like.

The operating unit 11 includes: a plurality of keys for inputting numerals, characters and symbols; a sensor that recognizes the pressed key; a transmission circuit that transmits a signal indicating the recognized key to the CPU 20; and the like.

The display unit 12 displays: a screen for displaying a message to a user; a screen for prompting a user to input settings or processes; a screen for indicating the result of a process executed at the MFP 101; and the like. In the present embodiment, a touch panel is used as the display unit 12. The touch panel may also be involved in the operating unit 11. The touch panel has a function of detecting the position in the touch panel touched by a user's finger and transmitting the signal indicating the detection result to the CPU 20.

The scanner unit 13 irradiates light on a document to detect reflected light, and read an image on the document with a predetermined scanning resolution so as to create digital image data (here, density data representing density of RGB or black).

The obtained data is used for printing at the printer unit 14. In addition, the data is converted into a file of a format such as TIFF, PDF, JPEG or the like and then stored in the hard disk 23. The image data may be converted into facsimile data and facsimile-transmitted. The image data may also be transmitted outside as attached to an e-mail as described above. The document feeder 17 is provided, for example, above the main body of the MFP 101 and used for sequentially feeding one or a plurality of documents to the scanner unit 13.

The printer unit 14 prints an image onto a recording sheet such as paper or film. The image may be from the data: being read by the scanner unit 3; being transmitted from an external device such as another MFP connected through a network such as LAN; or being received via a facsimile.

The sheet feeder 18 is provided, for example, below the main body of the MFP 101 and used for feeding the printer unit 14 a recording sheet. The printer unit 14 prints an image on the recording sheet and the printed recording sheet is ejected onto a catch tray, for example.

The communication interface 16 is an interface for communicating with an external device such as the PC 31 and the e-mail server 33 through a network such as LAN or WAN, and/or for transmitting and receiving a facsimile via a phone line. The communication interfaces 16 may include a network interface card (NIC) and/or a terminal adapter (TA).

Stored in the ROM 21 are a program and data for realizing basic functions of the MFP 101 such as reading (scanning) an image, duplicating (copying) a document, transmitting or receiving facsimile data, printing via a network, and operating as a document server (box function). Furthermore, the ROM 21 stores programs and data for realizing the functions according to the present embodiment.

Some or all of the programs or data may be installed in the hard disk 23. In this case, the program or data installed in the hard disk 23 may be loaded onto the RAM 22 as necessary.

The functions described in the present embodiment can be realized not only by using the CPU 20 but also by using dedicated hardware. Moreover, some of the functions may be realized by using functions provided by a general-purpose program such as an operating system (OS).

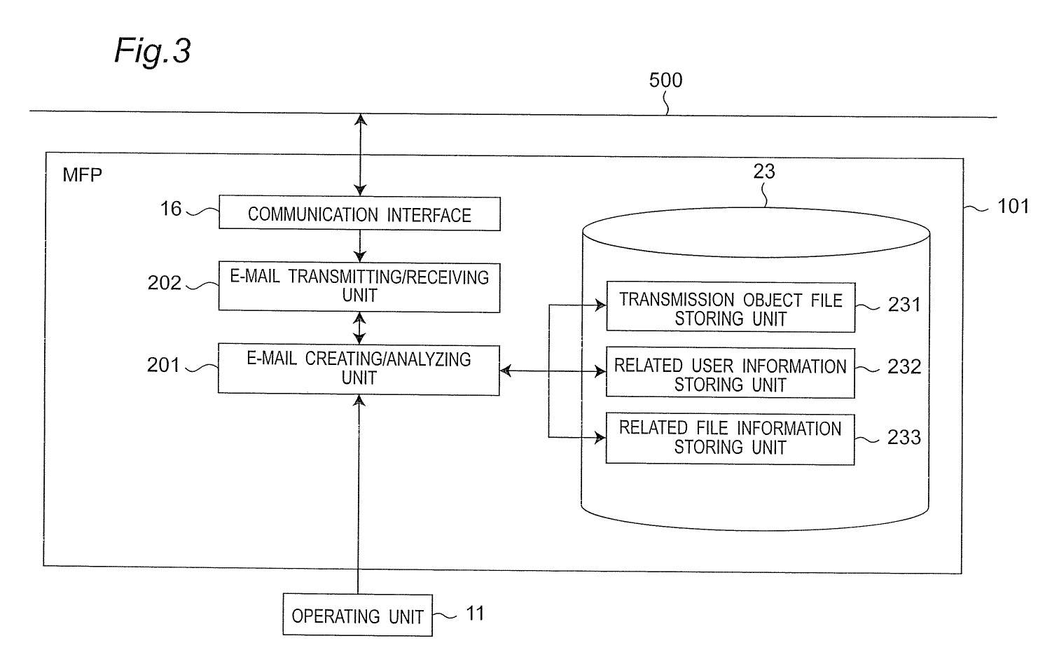

FIG. 3 is a block diagram for explaining an example of the functional configuration of the MFP 101 according to the present embodiment. The MFP 101 has an e-mail creating/analyzing unit 201 and an e-mail transmitting/receiving unit 202. The function of each units is realized by executing the program stored in the ROM 21 or RAM 22, on the CPU 20.

The hard disk 23 has a transmission object file storing unit 231, a related user information storing unit 232, and a related file information storing unit 233. The transmission object file storing unit 231 stores a transmission object file as attached to an e-mail, a related file which have been transmitted from outside as attached to an e-mail, or the like.

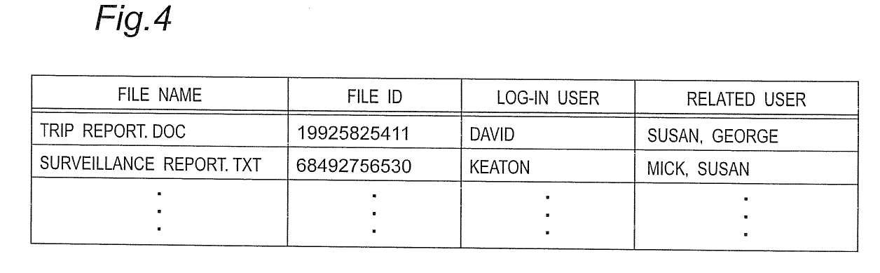

The related user information storing unit 232 stores related user information. FIG. 4 is a diagram for explaining an example of contents of the related user information. In the present embodiment, the related user information being stored in the related user information storing unit 232 includes: a file name and a file ID of a file which has been transmitted to the outside as attached to an e-mail; a user name of a log-in user at the time of the transmission; and a user name of a destination user of the file, who is a related user.

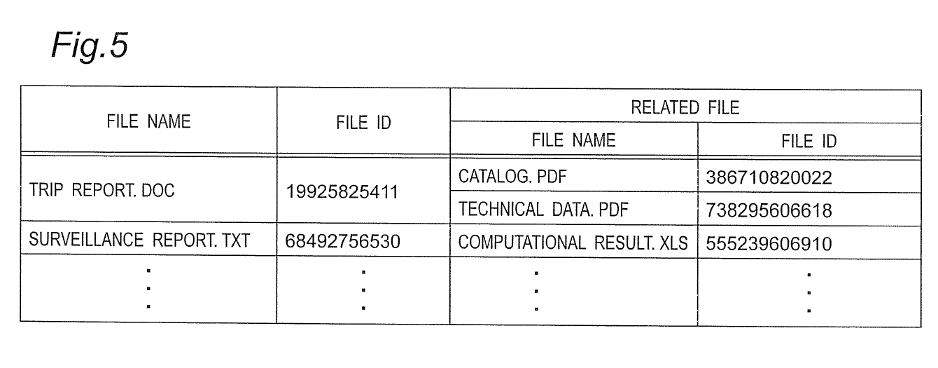

The related file information storing unit 233 stores related file information. FIG. 5 is a diagram for explaining an example of contents of the related file information. In the present embodiment, the related file information being stored in the related file information storing unit 233 includes: the file name and the file ID of the file (also referred to as an “associated file” hereinafter) which has been transmitted to the outside and included in the related user information; and a file name and a file ID of the related file. The file ID here in the present embodiment is the identifier of each file managed by the OS (operating system) of the MFP 101.

The related file is a file having relevance to the file which has been transmitted to the destination user. Association between them can appropriately be designated by a user through the operating unit 11. When the associated file is transmitted to the outside and a related file being relevant to the associated file is attached to the reply for this transmission, they may automatically be associated.

Referring to FIG. 3 again, upon the input from the operating unit 11, the e-mail creating/analyzing unit 201 creates an e-mail which is to be transmitted to the outside or analyzes an e-mail which is received from the outside. When an e-mail is transmitted to the outside, above mentioned process which associates a user with a file may be performed. Further, when an e-mail having a related file attached thereto is received, the related file is extracted and stored in the transmission object file storing unit 231, and the related file information is updated.

The e-mail transmitting/receiving unit 202 performs the transmission of an e-mail to the outside or reception of an e-mail from the outside through the communication interface 16.

(3) Processes in MFP 101

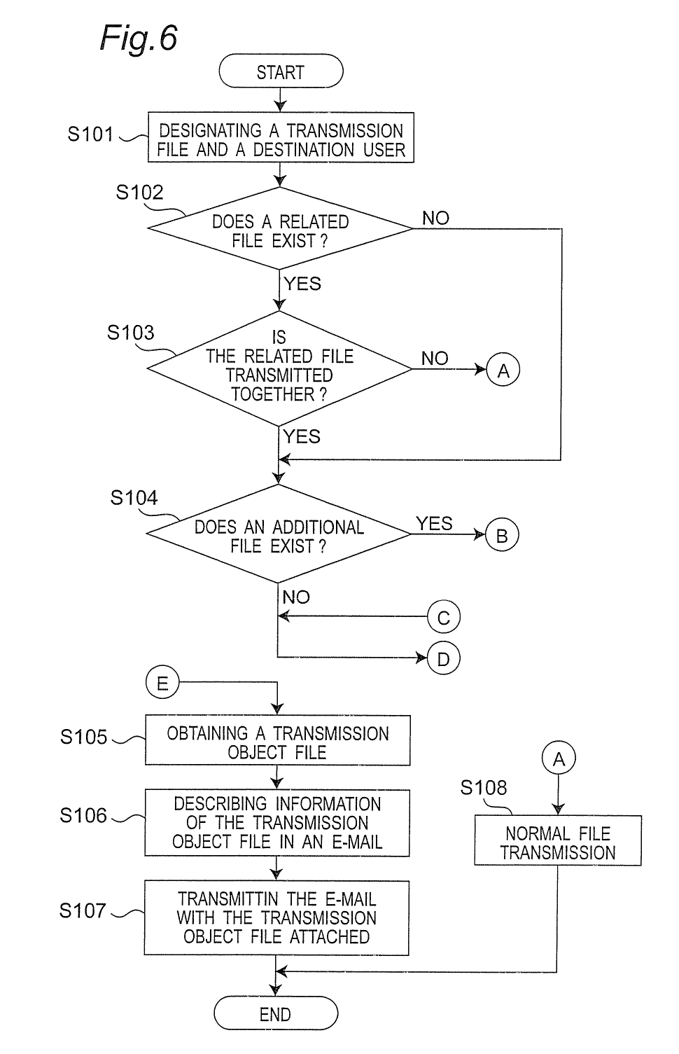

Processes in the MFP 101 according to the present embodiment will be described with reference to flowcharts. FIG. 6 is a flowchart for explaining an example of the processes in the MFP 101 when transmitting an e-mail having a file attached thereto to the outside.

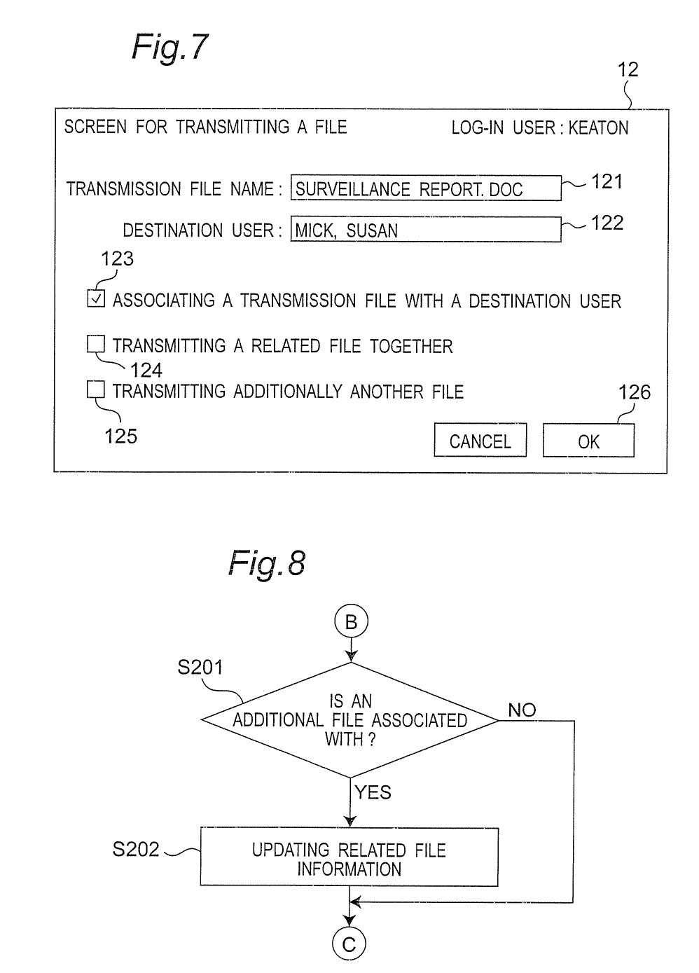

In the MFP 101, a file name of a transmission file and a destination user are designated through the operating unit 11 (S101). FIG. 7 is a diagram of an example of a screen displayed on the display unit 12 at this situation. The user may input the name of the transmission file in a transmission-file-name input box 121 of the screen as shown in FIG. 7, and input the name of the destination user in a destination-user-name input box 122.

When an OK button 126 is pressed, the process proceeds to the following process. The inputted destination-user name can be converted to the e-mail address of the destination user by referring to a user information table (not shown).

Referring to FIG. 6 again, the e-mail creating/analyzing unit 201 that have received the designation of the names of the transmission file and the destination user refers to the related file information stored in the related file information storing unit 233 to determine whether there exists a related file or not for the transmission file (S102).

When the related file does not exist (S102: NO), the process proceeds to step S104. In FIG. 6, when the related file for the transmission file exists (S102: YES), it is determined whether or not the related file is designated to be transmitted together (S103). This determination can be made by referring whether or not a check box 124 in the screen of FIG. 7 is checked. In addition, only when the related file for the transmission file does exist, the check box 124 is turned to be checkable.

When the related file is not designated to be transmitted (S103: NO), a usual transmission of an e-mail with a file attached thereto is carried out (S108). Specifically, only the file designated as the transmission file is transmitted as attached to the e-mail.

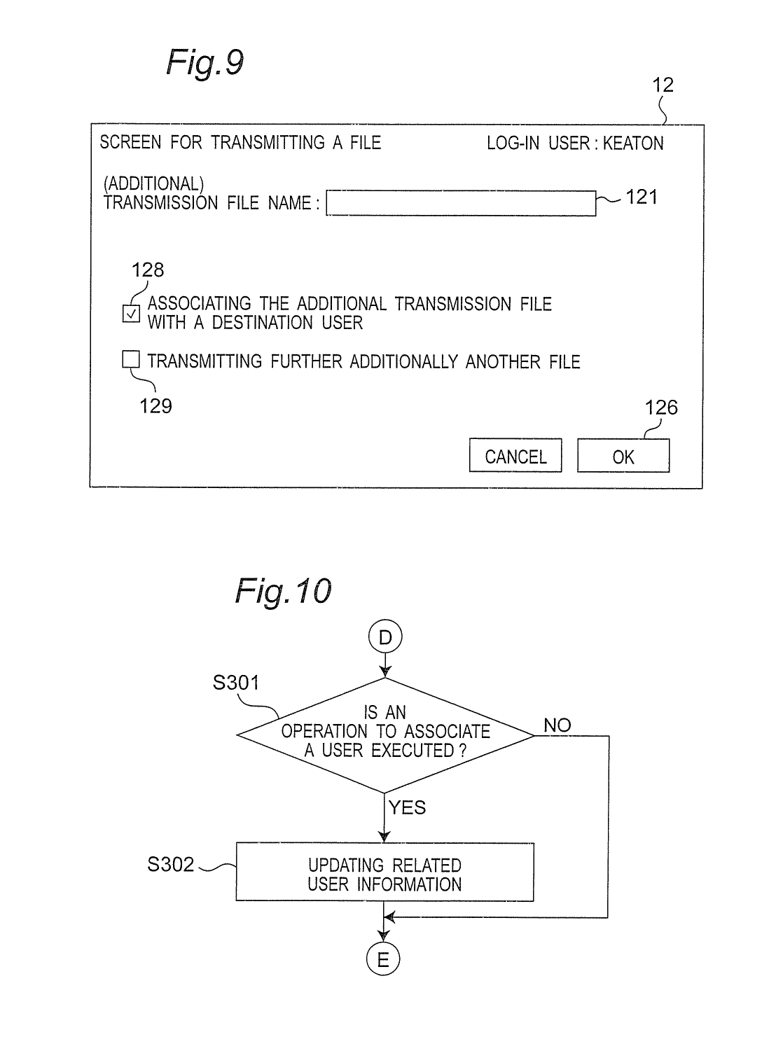

When a related file is designated to be transmitted (Sl03: YES), it is determined whether or not another file to be additionally transmitted exists (Sl04). This determination can be carried out by referring whether or not a check box 125 is checked. In addition, when the check box 125 is checked, a screen, an example of which is shown in FIG. 9, is displayed for designation of the additional file. With this configuration, it is possible to add and transmit the file when the related file is transmitted.

In the screen of FIG. 9, the additional file can be designated by inputting the name of the file in an additional transmission-file-name input box 127. When the OK button 126 is pressed with the additional file designated, it is determined that the determination in step S104 of FIG. 6 results in YES, so that the process proceeds to the flowchart of FIG. 8.

In the flowchart of FIG. 8, it is determined whether or not the association for the additional file is carried out (S201). This determination can be made by referring whether or not a check box 128 is checked. When the association of the additional file is performed (S201: YES) , the related file information is updated (S202). By this processing, the additional file is registered as a related file of the transmission file that is firstly inputted in the box 121 in FIG. 7. Although the additional file is not recognized as one identical to a related file, this processing makes it possible to temporarily add the additional file to the related file and transmit the same, which enhances convenience.

Thereafter, the process proceeds to the flowchart of FIG. 10 in which it is determined whether or not execution of an operation to associate the transmission file with the destination user is designated (S301). This determination can be made by referring whether or not a check box 123 in the screen of FIG. 7 is checked. By using this check box 123, a user who is going to transmit a file can optionally associate the transmission file with the destination user.

When it is designated that the association is to be performed (S301: YES), the related user information is updated (S302). Specifically, a correspondence relationship among the transmission file name, the log-in user and the destination user is added to the table in FIG. 4. When the operation of association is not performed (S301: NO), the process returns to the chart of FIG. 6 without updating the related user information. This is to handle the transmission of a file that does not particularly need the operation of associating.

Another additional file can be designated by checking a check box 129 in the screen in FIG. 9 before pressing the OK button 126. When the OK button 126 is pressed with the check box 129 not checked, it is determined that the determination in step S104 in the flowchart of FIG. 6 results in NO, so that the process proceeds to the process charted in FIG. 10. When the OK button 126 is pressed with the additional-transmission-file-name input box 127 being blank even if the check box 129 is checked, the process may proceed to the process charted in FIG. 10.

In step S105 in FIG. 6, the transmission object file that is to be transmitted as attached to the e-mail is obtained. The transmission object file can include: the transmission file; related file; and additional file, according to the designation of the user. Then, the information of the transmission object file is described in the e-mail to be transmitted (S106), and the e-mail having the transmission object file attached thereto is transmitted (S107). The file ID contained in the related user information or the related file information can be described as the information of the transmission object file as well as the file name of the transmission object file.

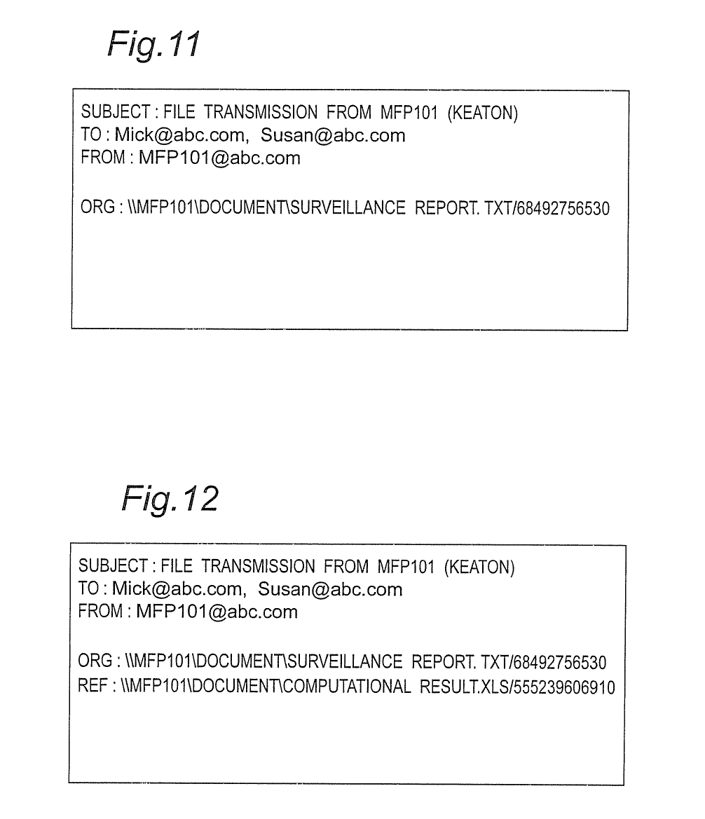

It is to be noted that it is not always needed to attach the transmission object file to the e-mail. Only the information indicating the location of the transmission object file may be added in the e-mail in step S106. FIG. 11 is a diagram of an example of the content of the e-mail that describes the information indicating the location of the transmission file. FIG. 12 is a diagram of an example of the content of the e-mail that also describes the information indicating the location of the related file.

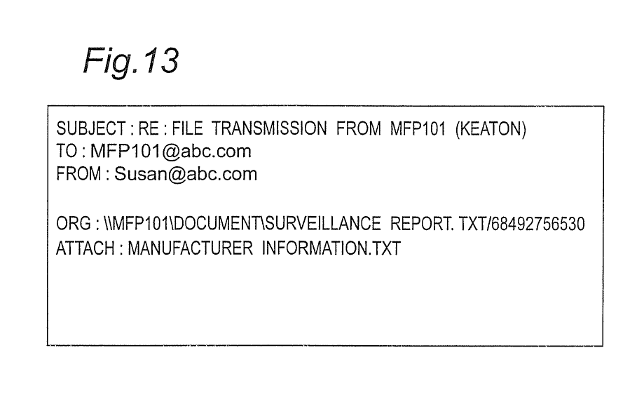

On the other hand, the user who receives the e-mail as described above can transmit an e-mail having a related file attached thereto to the MFP 101 as the reply to that e-mail. In the document management device according to the present embodiment, when the user transmits the e-mail having a related file attached thereto, it is automatically registered in the related file information as the related file. The processes in the MFP 101 in this case will be described below. FIG. 13 is a diagram of an example of the content of the reply e-mail in this case. In the example of this figure, the reply from the user describes the information indicating “Surveillance Report.txt” that is the transmission file, and has attached thereto a file of “Manufacturer Information.txt.”

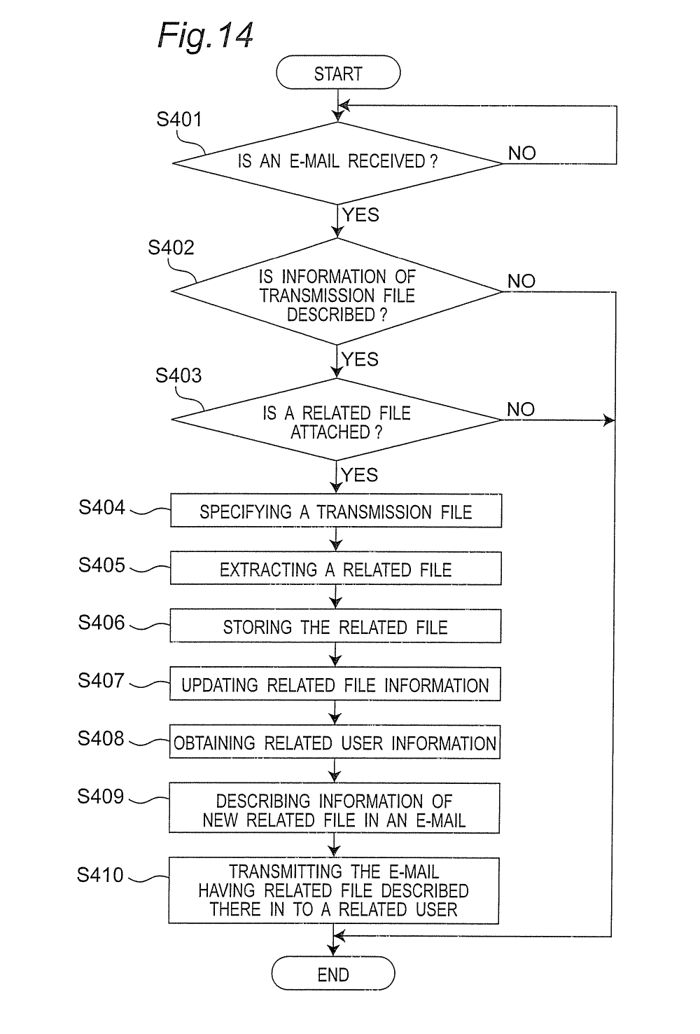

FIG. 14 is a flowchart for explaining an example of the processes in the MFP 101 when the MFP 101 receives the reply e-mail described above.

When the MFP 101 receives the e-mail (S410: YES), it is determined whether or not the information of the transmission file such as “Surveillance Report.txt” which is the transmission file above mentioned and the file ID are described (S402).

When the information of the transmission file is not described (S402: NO), the processes are completed. When the information of the transmission file is described (S402: YES), it is determined whether or not the related file is attached (S403). When the related file is not attached (S403: NO), the processes are completed. In addition, a configuration in which, when the information of the transmission file is similar to the one registered as the related user information or related file information, a confirmation screen is displayed is possible.

When the related file is attached (S403: YES), the transmission file is specified (S404). This process can easily be performed by means of the content of “ORG” field of the e-mail in FIG. 13.

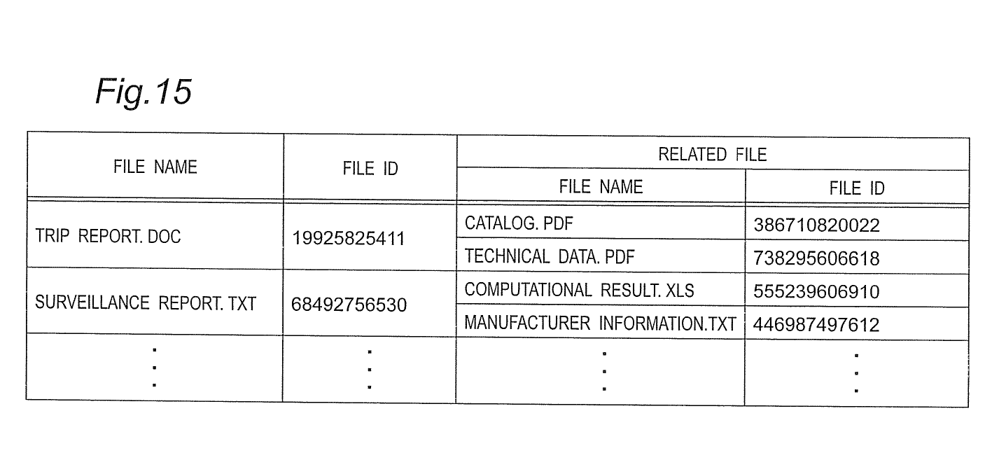

Next, the related file is extracted (S405) and stored in the transmission object file storing unit 231 (S406). Then, the related file information is updated (S407). The reason why the related file information is updated is that a new related file is added by the reply e-mail from the user. If the file that has already been registered as the related file is received again, the above-mentioned process can be skipped. FIG. 15 is a diagram of an example of the updated related file information. In the example of this figure, the file of “Manufacturer Information.txt” is added as a related file together with the file ID of the MFP 101.

Next, the related user information is obtained (S408). The related user information can be obtained from the related user information shown in FIG. 4 on the basis of the transmission file specified at step S404. Then, information of a new related file is described in an e-mail (S409), and the e-mail having the information of the related file described therein is transmitted to the related user obtained at step S408 (S410). The new related file may be attached to this e-mail, or information indicating the location of the new related file may be described in this e-mail so as to omit the attachment of the file.

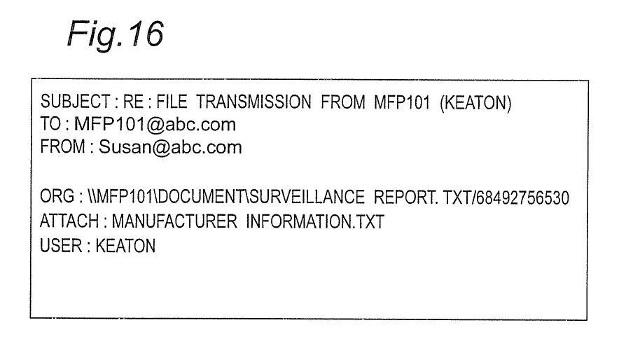

In addition, the user who transmits the related file can make a designation so as to limit the destination user of the e-mail having the information of the related file described therein. FIG. 16 is a diagram of an example of the content of the reply e-mail in this case. In the example of this figure, the user “Keaton” is designated in the field of “USER” in the body of the e-mail.

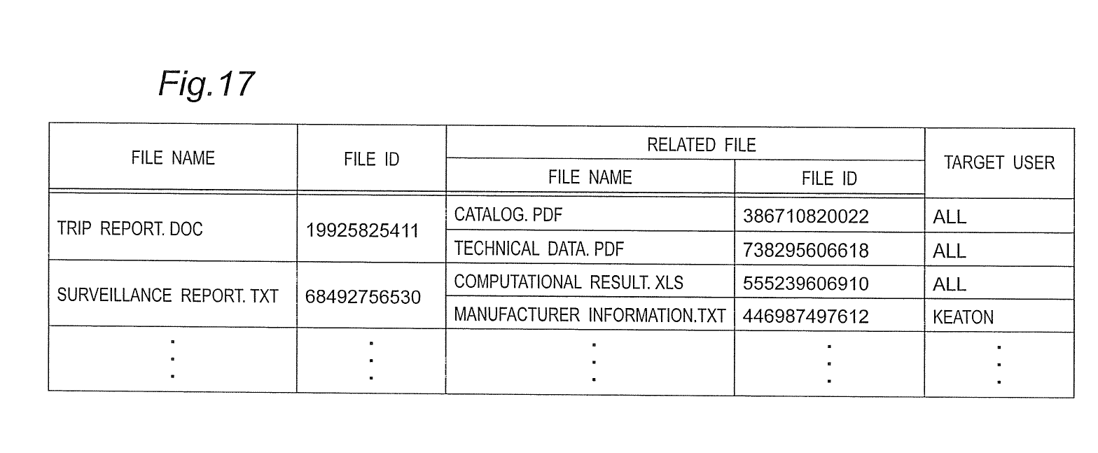

The MFP 101 that receives this e-mail can memorize the target user designated in the related file information and limit the transmission destination of the e-mail at step S410 of FIG. 4 to the target user, as shown in FIG. 17, for example. The limitation of the target user can be set not only as the limited transmission of the e-mail but also as the access authorizations of the related file. Although “Keaton” who is the user transmitting the associated file is designated in the example in FIG. 16, another user can be designated, and a plurality of users can be designated.

(Modification)

The embodiment according to the present invention has been described above. It is needless to say that the present invention is not limited by the specific examples described in the above embodiment, and a modification described below may be possible, for example.

Although detailed description is omitted in the above embodiment, a new related user can additionally be registered by the user through the operating unit 11, for example. The additional registration can be carried out from outside with using means such as an e-mail. The related user newly registered may be managed similarly to the normal related user (the destination user of the associated file) in the related user information in FIG. 4, or may be managed in another field which is different from the normal related user.

In this case, the configuration in which, when a new member is added to a project team, the related file of a selected file is informed the related user newly registered is convenient for communication, for example. Also in this case, the related file may be transmitted as attached to an e-mail, or the information relating to the location of the related file, such as the path of the related file, may be transmitted as described in the e-mail.

The present invention is applicable to a document management device that is installed to an MFP, or the like. The present invention is also applicable to a computer program stored on a computer readable medium such as a flexible disk (FD), a compact disc read only memory (CD- ROM), or the like.

What is claimed is:

1. A document management device comprising:
a file information transmitter that transmits information being related to a first file to one or more destination users designated by a first user;
a related user information storing unit that stores, as a related user, the destination user in association with the first file;
a related file extractor that extracts a related file when a reply from any one of the destination users includes the related file together with identification information of the first file;
a file storing unit that stores the related file; and
a related file informer that informs the related user other than the user who has transmitted the related file when a new related file is stored in said file storing unit.

2. The document management device according to claim 1, further comprising a related user registration receiving unit that receives an additional registration of the related user.

3. The document management device according to claim 1, wherein
the related file informer further informs the information relating to the related file of the first file of a new related user, when the new related user is added for the first file.

4. The document management device according to claim 1, further comprising:
a related file transmission determining unit that determines whether or not the information relating to the related file of the first file is transmitted together, when the transmission of the first file to the outside is instructed, wherein
the file information transmitting unit transmits the information relating to the related file together with the information relating to the first file when it is determined that the information relating to the related file is transmitted together.

5. The document management device according to claim 1, further comprising:
a related user information storage determining unit that determines whether the destination user is stored in the related user information storing unit as the related user when the information is transmitted by the file information transmitting unit.

6. The document management device according to claim 1, further comprising:
an additional file transmission determining unit that determines whether or not information relating to an additional file is transmitted additionally when the information is transmitted by the file information transmitting unit, wherein
the file information transmitting unit transmits the information relating to the additional file together with the information relating to the first file when it is determined that the information relating to the additional file is transmitted together.

7. The document management device according to claim 6, further comprising an additional file association determining unit that determines whether or not the additional file is defined as the related file.

8. The document management device according to claim 1, further comprising a related file information storing unit that stores the correspondence relationship between the first file and the related file.

9. The document management device according to claim 1, wherein
the related file informer informs the information relating to the related file only to the user designated by the user who has transmitted the related file.

10. The document management device according to claim 1, wherein the related file informer carries out the informing by transmitting an electronic mail having the related file attached thereto.

11. The document management device according to claim 1, wherein the related file informer carries out the informing by transmitting an electronic mail having the location of the related file described therein.

12. A computer program stored on a computer readable medium for causing a processor to operate processes, comprising:
code that transmits information relating to a first file to one or more destination users designated by a first user;
code that extracts a related file when a reply from any one of the destination users includes the related file together with identification information of the first file; and
code that informs the related user other than the user who has transmitted the related file when a new related file is extracted.
